(19) United States
(12) Patent Application Publication
(10) Pub. No.: US 2011/0255465 A1
(43) Pub. Date: Oct. 20, 2011

(54) WIMAX VOIP SERVICE ARCHITECTURE

(76) Inventors: Chang Hong Shan, Shanghai (CN); Muthaiah Venkatachalam, Beaverton, OR (US)

(21) Appl. No.: 12/940,288

(22) Filed: Nov. 5, 2010

Related U.S. Application Data
(60) Provisional application No. 61/325,184, filed on Apr. 16, 2010.

(51) Int. Cl. H04W 4/00; H04L 12/66

(52) U.S. Cl. 370/328; 370/352

(57) ABSTRACT

A wireless communication system to support voice over internet protocol (VoIP) service is presented. In one embodiment, the system includes a connectivity service network comprising a voice over internet protocol (VoIP) gateway to enable the VoIP service. The VoIP gateway is operable to perform transcoding function to support VoIP data plane communication. The connectivity service network also includes a home agent and an authentication, authorization, and accounting server (AAA server). In one embodiment, the connectivity service network includes a VoIP service server.

### CROSS-REFERENCE TO RELATED APPLICATIONS

This application claims the benefit of U.S. Provisional Application No. 61/325,184, filed on Apr. 16, 2010, which is incorporated herein by reference as if set forth herein in full.

### FIELD OF THE INVENTION

Embodiments of the invention relate to wireless communications, more particularly, embodiments of the invention relate to providing voice over internet protocol (VoIP) service.

### BACKGROUND OF THE INVENTION

A broadband wireless access (BWA) system provides a point-to-multipoint communication system in a communications network. BWA systems typically use microwave and millimeter wave technology to transmit communication signals from a wireless base station (BS) to one or more subscriber stations (SS) and/or mobile subscriber stations (MS). A BWA system may be a converged wireless network designed to provide voice, video, and data services.

Mobile Worldwide Interoperability for Microwave Access (WiMAX) is a broadband wireless access technology based on Institute of Electrical and Electronics Engineers (IEEE) 802.16 standard. Mobile WiMAX uses a scalable orthogonal frequency division multiple access (OFDMA) scheme to deliver wireless broadband packet data services to mobile terminals. The 802.16 family of standards were developed by the Institute of Electrical and Electronic Engineers (IEEE) to provide for fixed, portable, and/or mobile BWA networks (e.g., the IEEE std. 802.16, published 2004 and subsequent revisions).

In downlink transmissions, WiMAX networks may broadcast data packets from BS to SS or MS; whereas in the uplink transmissions, the scheduling services may be designed to support services with different traffic characteristics and Quality of Service (QoS) requirements. A significant benefit of the converged wireless networks, such as a WiMAX network, is in the sharing of the most valuable resources—the wireless spectrum among different services.

### BRIEF DESCRIPTION OF THE DRAWINGS

Embodiments of the present invention will be understood more fully from the detailed description given below and from the accompanying drawings of various embodiments of the invention, which, however, should not be taken to limit the invention to the specific embodiments, but are for explanation and understanding only.

FIG. 1 is block diagram of a wireless communication system to support voice of internet protocol (VoIP) service, in accordance with one embodiment of the invention.

FIG. 2 is block diagram of a wireless communication system where QoS functions are supported by an Authentication, Authorization and Accounting Server (AAA server), in accordance with one embodiment of the invention.

FIG. 3 is block diagram of a wireless communication system where QoS functions are supported by a VoIP gateway in conjunction with a WiMAX VoIP service server (WVS) as a part of the connectivity service network (CSN), in accordance with one embodiment of the invention.

FIG. 4 is block diagram of a wireless communication system where QoS functions are supported by an AAA server in conjunction with a WVS server as a part of the CSN, in accordance with one embodiment of the invention.

FIG. 5 is block diagram of a wireless communication system where QoS functions are supported by a VoIP gateway in conjunction with a WVS server placed together with the VoIP gateway, in accordance with one embodiment of the invention.

FIG. 6 is block diagram of a wireless communication system where QoS functions are supported by an AAA server in conjunction with a WVS server placed together with the VoIP gateway, in accordance with one embodiment of the invention.

FIG. 7 is a flow diagram of one embodiment of a process to provide VoIP service in conjunction with a WiMAX network.

FIG. 8 is a diagram representation of a wireless communication system in accordance with one embodiment of the invention.

### DETAILED DESCRIPTION OF THE INVENTION

A wireless communication system to support voice over internet protocol (VoIP) service is presented. In one embodiment, the system includes a connectivity service network comprising a voice over internet protocol (VoIP) gateway to enable the VoIP service. The VoIP gateway is operable to perform transcoding function to support VoIP data plane communication. The connectivity service network also includes a home agent and an authentication, authorization, and accounting server (AAA server). In one embodiment, the connectivity service network includes a VoIP service server.

In the following description, numerous details are set forth to provide a more thorough explanation of embodiments of the present invention. It will be apparent, however, to one skilled in the art, that embodiments of the present invention may be practiced without these specific details. In other instances, well-known structures and devices are shown in block diagram form, rather than in detail, in order to avoid obscuring embodiments of the present invention.

Some portions of the detailed descriptions which follow are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments of present invention also relate to apparatuses for performing the operations herein. Some apparatuses may be specially constructed for the required purposes, or it may comprise a general purpose computer selectively activated or reconfigured by a computer program stored in the computer. Such a computer program may be stored in a computer readable storage medium, such as, but not limited to, any type of disk including floppy disks, optical disks, CD-ROMs, DVD-ROMs, and magnetic-optical disks, read-only memories (ROMs), random access memories (RAMs), EPROMs, EEPROMs, NVRAMs, magnetic or optical cards, or any type of media suitable for storing electronic instructions, and each coupled to a computer system bus.

The method and apparatus described herein are for providing VoIP service in conjunction with a wireless network. The methods and apparatus for providing the VoIP service are not so limited, as they may be implemented on or in association with any integrated circuit device or system, such as cell phones, personal digital assistants, embedded controllers, mobile platforms, desktop platforms, and server platforms, as well as in conjunction with other resources.

### Overview

A wireless communication system to support voice over internet protocol (VoIP) service is presented. In one embodiment, the system includes a connectivity service network comprising a voice over internet protocol (VoIP) gateway to enable the VoIP service. The VoIP gateway is operable to perform transcoding function to support VoIP data plane communication. The connectivity service network also includes a home agent and an authentication, authorization, and accounting server (AAA server). In one embodiment, the connectivity service network includes a VoIP service server.

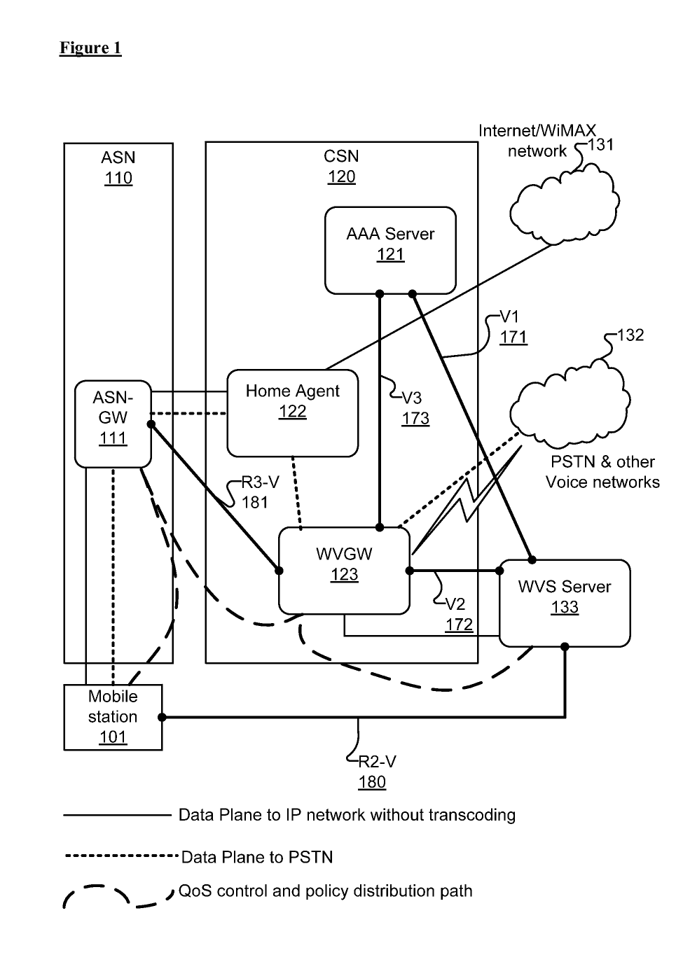

FIG. 1 is block diagram of a wireless communication system to support voice of internet protocol (VoIP) service, in accordance with one embodiment of the invention. Many related components such as buses and peripherals have not been shown to avoid obscuring the invention. Referring to FIG. 1, in one embodiment, the system comprises access service network (ASN 110), mobile station 101, connectivity service network (CSN 120), internet/WiMAX network 131, PSTN (public switched telephone network) & other voice networks 132, and WiMAX VoIP service server (WVS server 133). ASN 110 further includes access service network-gateway (ASN-GW 111). CSN 120 further includes authentication, authorization and accounting server (AAA server 121), home agent (HA 122), and WiMAX VoIP gateway (WVGW 123).

In one embodiment, AAA server 121 communicates with WVS server 133 via V1 171 interface. WVS server 133 communicates with WVGW 123 via V2 172 interface. AAA server 121 communicates with WVGW 123 via V3 173 interface. WVS server 133 communicates with mobile station 101 via R2-V 180 interface. WVGW 123 communicates with ASN-GW 111 via R3-V 181 interface.

The communication path for data plane to the IP network without transcoding is shown with a solid line. For example, the path includes mobile station 101, ASN-GW 111, HA 122, and WiMAX network 131.

The communication path for data plane to PSTN is shown with a dotted line. For example, the path includes mobile station 101, ASN-GW 111, HA 122, WVGW 123, and PSTN & other voice networks 132.

The communication path for quality of service (QoS) and policy distribution is indicated with a dashed line. For example, the path includes mobile station 101, ASN-GW 111, WVGW 123, and WVS server 133.

In one embodiment, WVGW 123 performs a transcoding function, a signaling transition function, and optionally a QoS policy delivery function. In one embodiment, WVGS 123 includes transcoding functions, QoS control, and policy enforcement functions and provides bearer connectivity with a PSTN.

In one embodiment, WVS server 133 acts as a session initiation protocol (SIP) registrar server, a SIP location server, a SIP redirect server. For example, WVS server 133 includes the functionality of SIP UAC, SIP UAS, SIP registrar, redirect server, SIP signaling transition, QoS and policy distribution, and AAA client.

In one embodiment, WVGW 123 and WVS server 133 are collocated/implemented in a same entity (e.g., a physical server, a network) or in two different entities. In one embodiment, V2 172 is an internal interface and may not be needed if WVGW 123 and WVS server 133 are collocated.

In one embodiment, the signaling transition function supports the communication for control plane between a WiMAX network and a non-WiMAX network (e.g., PSTN, 3GPP2 Voice, and 3GPP voice system). The transcoding function supplies the communication for data plane between VoIP clients which use different codecs.

In one embodiment, the QoS policy delivery function helps to obtain QoS requirements from WVS server 133 and deliver the QoS policy/decision to WiMAX network elements. WVS server 133 is placed in a WiMAX network or a service provider's network.

In one embodiment, WVS server 133 is not within the scope of CSN 120 because the operator plans to support a service provider based VoIP, such as, for example, Skype, etc.

In one embodiment, as to policy distribution and QoS control, V2 172 interface acts as a Rx/Tx interface between an ASP (Application Service Provider) and a PCC (Policy and Charging Control) architecture. Thus, WVGW 123 performs a policy and charging rules function (PCRF) and a policy distribution function (PDF).

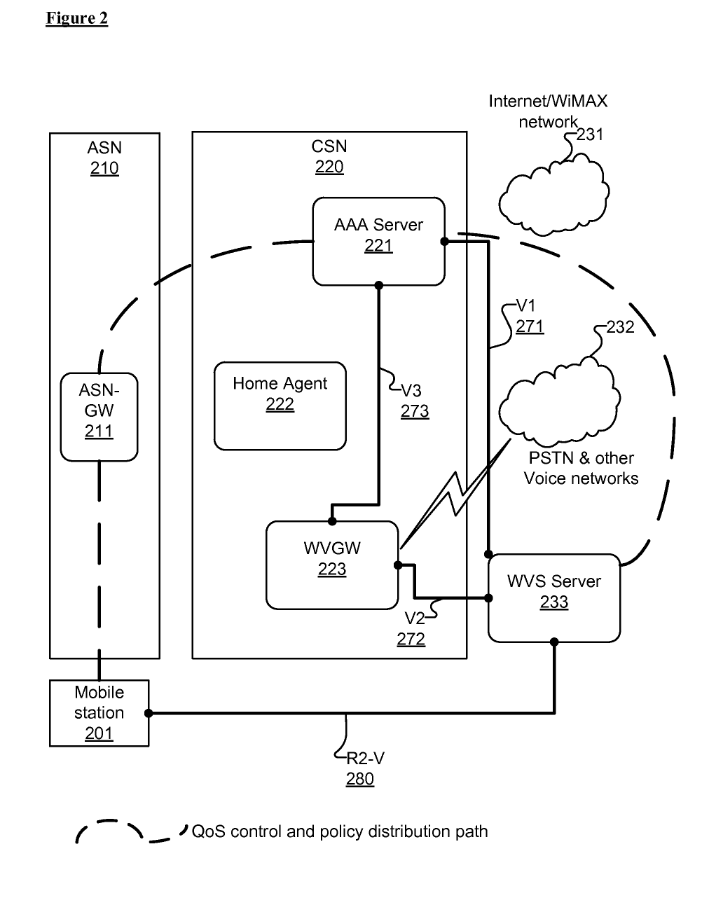

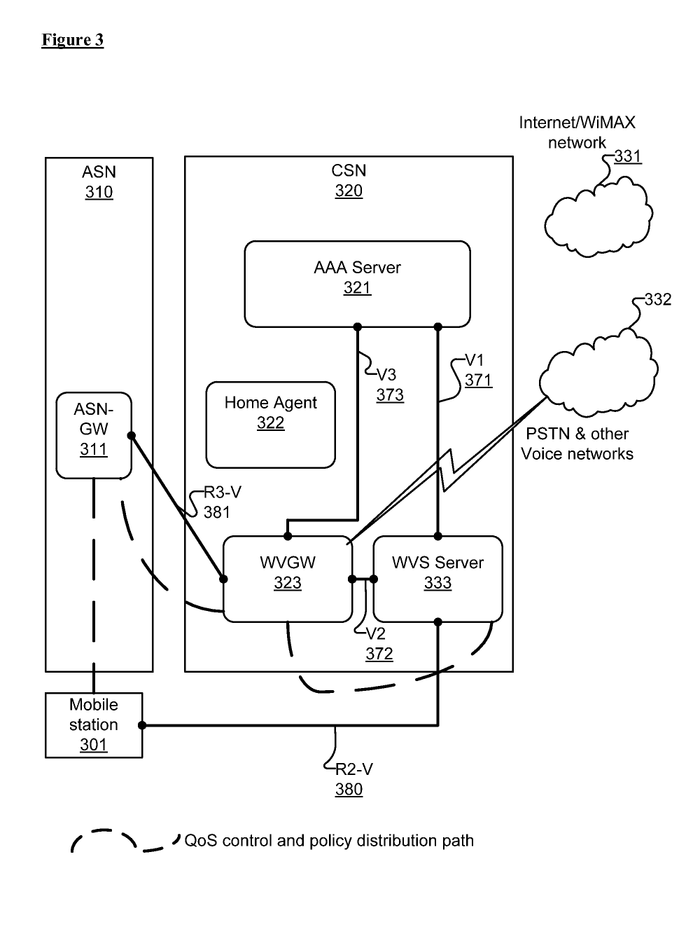

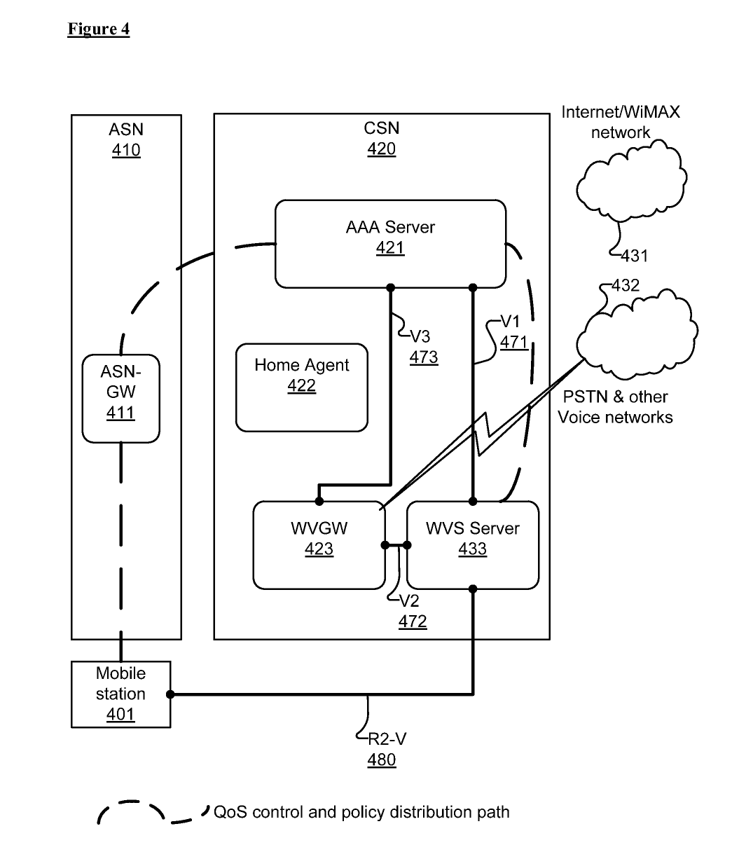

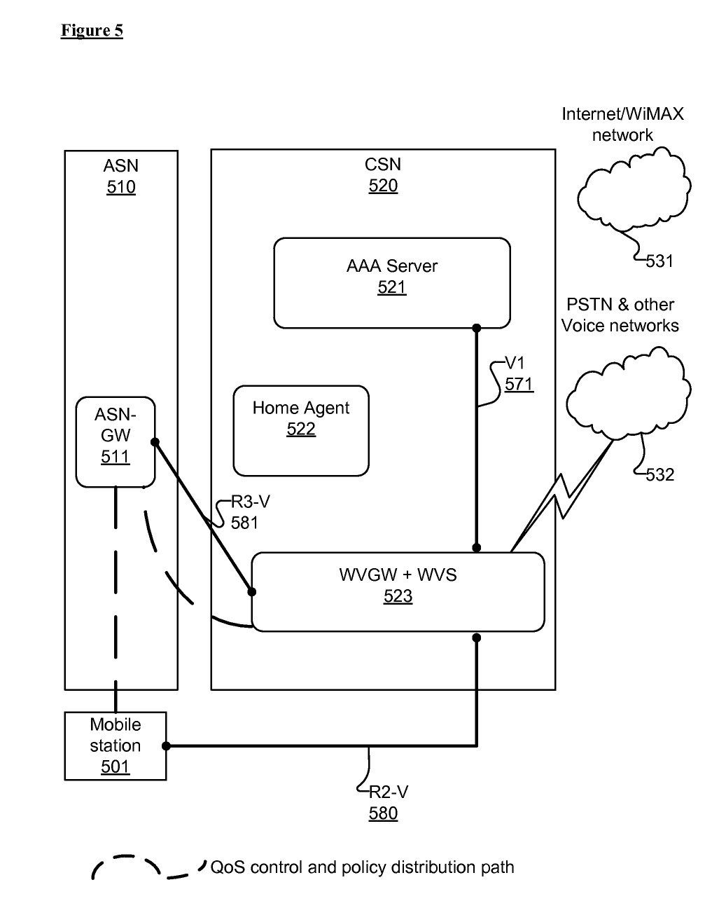

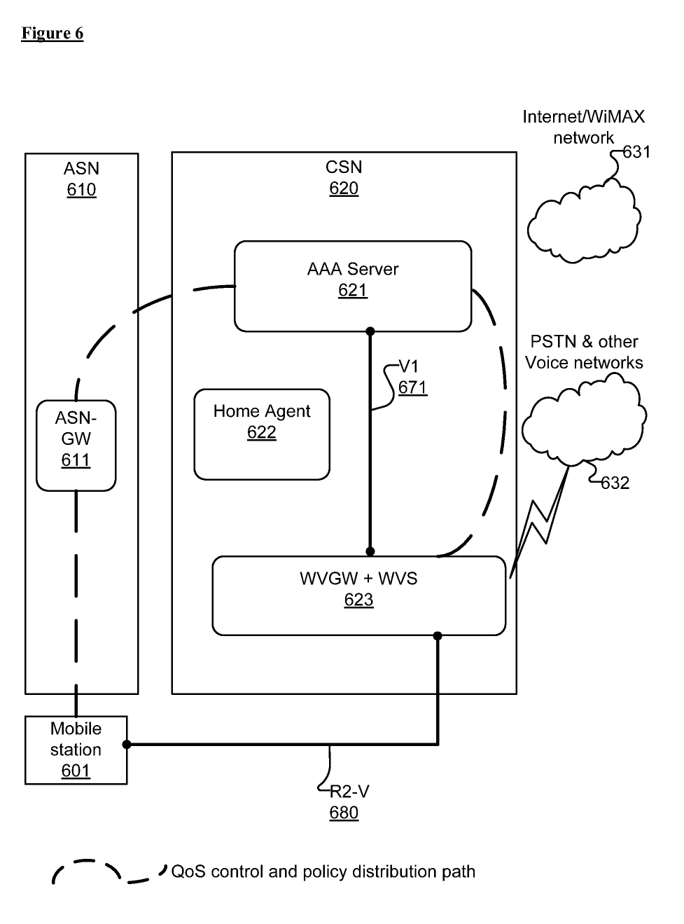

In one embodiment, the QoS policy delivery function is performed in conjunction with WVGW 123 (e.g., with respect to FIG. 1, FIG. 3, and FIG. 5). In one embodiment, the QoS policy delivery function is performed by (located in) AAA server 121 (e.g., with respect to FIG. 2, FIG. 4, and FIG. 6).

In one embodiment, AAA server 121 supports authorization and accounting functionality.

In one embodiment, WVGW 123 is not involved in the data plane if transcoding is not required. In a simple IP case, there is no HA 122 if HA 122 is replaced by an anchor router in CSN 120.

Referring to FIG. 1, in one embodiment, the QoS function is performed by WVGW 123. There is an interface between WVS server 133 and WVGW 123 and an interface between WVGW 123 and ASN-GW 111. If signaling transition is required between WVS server 133 and other non-WiMAX VoIP systems, the signaling propagates through WVGW 123. If transcoding is required between VoIP clients using different codecs, data packets propagates through WVGW 123.

In one embodiment, V1 171 is an interface (also referred to herein as an interconnection) between WVS server 133 and AAA server 121. V1 171 is for WVS subscriber authentication and authorization, and exchanging accounting messages, such as, for example, accounting start, accounting stop, etc.

In one embodiment, V2 172 is an interface between WVS server 133 and WVGW 123. V2 127 is for policy distribution, QoS control, and signaling transition between WVS server 133 and other voice systems.

In one embodiment, V3 173 is an interface between WVGW 123 and AAA server 121. V3 173 is for exchanging accounting messages, such as, for example, accounting start and accounting stop, etc.

In one embodiment, R2-V 180 is an interface between mobile station 101 and WVS server 133. R2-V 180 is for user registration, deregistration, calling setup and teardown.

In one embodiment, R3-V 181 is an interface between WVGW 123 and ASN-GW 111. R3-V 181 is for policy distribution and QoS control.

In one embodiment, WVS server 133, AAA server 121, and WVGW 123 are located in VoIP service network (VSN). The VSN is a part of a VoIP service provider (VSP). In one embodiment, the VSP is an independent third party service provider or part of network service provider (NSP), such as, for example, CSN 120. In one embodiment, the VSN has an interface with a PSTN for signaling and data transfer with or without any transcoding operation. In one embodiment, interface Rv is an interface between the VSN and CSN 120 if the VSN is not part of CSN 120.

In one embodiment, a base station (not shown) is a transmitter in a downstream or downlink case. A transmitter may be interchangeably referred to as an advance base station, a base station (BS), an enhanced Node B (eNB), or an access point (AP) at the system level herein. In this downlink case, mobile station 101 is a receiver. A receiver may be interchangeably referred to as an advanced mobile station (AMS), a mobile station (MS), a subscriber station (SS), a user equipment (UE), or a station (STA) at the system level herein. Further, the terms ABS, BS, eNB, and AP may be conceptually interchanged, depending on which wireless protocol is being used, so a reference to BS herein may also be seen as a reference to either of ABS, eNB, or AP. Similarly, a reference to MS herein may also be seen as a reference to either of AMS, SS, UE, or STA.

FIG. 2 is block diagram of a wireless communication system where QoS functions are supported by an Authentication, Authorization and Accounting Server (AAA server), in accordance with one embodiment of the invention.

Many related components such as buses and peripherals have not been shown to avoid obscuring the invention. Data plane to IP network without transcoding and data plane to the PSTN are not shown to avoid obscuring the invention. Referring to FIG. 2, in one embodiment, the system comprises access service network (ASN 210), mobile station 201, connectivity service network (CSN 220), Internet/WiMAX network 231, PSTN (public switched telephone network) & other voice networks 232, and WiMAX VoIP service server (WVS server 233). ASN 210 further includes access service network-gateway (ASN-GW 211). CSN 220 further includes authentication, authorization and accounting server (AAA server 221), home agent (HA 222), and WiMAX VoIP gateway (WVGW 223).

In one embodiment, AAA server 221 communicates with WVS server 233 via V1 271 interface. WVS server 233 communicates with WVGW 223 via V2 272 interface. AAA server 221 communicates with WVGW 223 via V3 273 interface. WVS server 233 communicates with mobile station 201 via R2-V 280 interface.

In one embodiment, the QoS function is performed by AAA server 221 and WVS server 233 is not in CSN 220. There is an interface between WVS server 233 and AAA server 221 and an interface between AAA server 221 and ASN-GW 211. If signaling transition is required between WVS server 233 and other non-WiMAX VoIP systems, the signaling propagates through WVGW 223. If transcoding is required between VoIP clients using different codecs, the data packets propagate through WVGW 223.

In one embodiment, V1 271 is an interface between WVS server 233 and AAA server 221. V1 271 is for WVS subscriber authentication and authorization, policy distribution and QoS control, and exchanging accounting messages, such as, for example, accounting start, accounting stop, etc.

In one embodiment, V2 272 is an interface between WVS server 233 and WVGW 223. V2 272 is for signaling transition between WVS server 233 and other voice systems.

In one embodiment, V3 273 is an interface between WVGW 273 and AAA server 221. It is for exchanging accounting messages, such as, for example, accounting start and accounting stop, etc.

In one embodiment, R2-V 280 is an interface between mobile station 201 and WVS server 233. R2-V 280 is for user registration, deregistration, calling setup and teardown.

In one embodiment, a network element (e.g., ASN 210, mobile station 201, CSN 220, WVS server 233, ASN-GW 211, AAA server 221, HA 222, and WVGW 223) or an interface (e.g., V1 271, V2 272, V3 273, and R2-V 280), unless otherwise described above, performs functions and roles substantially similar to the corresponding element or the corresponding interface with respect to FIG. 1. For example, ASN-GW 211 performs functionality similar to ASN-GW 111 with respect to FIG. 1; mobile station 201 acts in accordance with mobile station 101 in FIG. 1; etc.

FIG. 3 is block diagram of a wireless communication system where QoS functions are supported by a VoIP gateway in conjunction with a WiMAX VoIP service server (WVS) as a part of the connectivity service network (CSN), in accordance with one embodiment of the invention.

Many related components such as buses and peripherals have not been shown to avoid obscuring the invention. Data plane to IP network without transcoding and data plane to the PSTN are also not shown to avoid obscuring the invention. Referring to FIG. 3, in one embodiment, the system comprises access service network (ASN 310), mobile station 301, connectivity service network (CSN 320), Internet/WiMAX network 331, and PSTN (public switched telephone network) & other voice networks 332. ASN 310 further includes access service network-gateway (ASN-GW 311). CSN 320 further includes authentication, authorization and accounting server (AAA server 321), home agent (HA 322), WiMAX VoIP gateway (WVGW 323), and WiMAX VoIP service server (WVS server 333).

In one embodiment, AAA server 321 communicates with WVS server 333 via V1 371 interface. WVS server 333 communicates with WVGW 323 via V2 372 interface. AAA server 321 communicates with WVGW 323 via V3 373 interface. WVS server 333 communicates with mobile station 301 via R2-V 380 interface. WVGW 323 communicates with ASN-GW 311 via R3-V 381 interface.

In one embodiment, WVS server 333 is located in CSN 320 (e.g., with respect to FIG. 3). The difference between FIGS. 3 and 1 is that WVS server 333 is located in CSN 320.

In one embodiment, a network element (e.g., ASN 310, mobile station 301, CSN 320, WVS server 333, ASN-GW 311, AAA server 321, HA 322, and WVGW 323) or an interface (e.g., V1 371, V2 372, V3 373, R2-V 380, and R3-V 381), unless otherwise described above, performs functions and roles substantially similar to the corresponding element or the corresponding interface with respect to FIG. 1. For example, ASN-GW 311 performs functionality similar to ASN-GW 111 with respect to FIG. 1; mobile station 301 acts in accordance with mobile station 101 in FIG. 1; etc.

FIG. 4 is block diagram of a wireless communication system where QoS functions are supported by an AAA server in conjunction with a WVS server as a part of the CSN, in accordance with one embodiment of the invention.

Many related components such as buses and peripherals have not been shown to avoid obscuring the invention. Data plane to IP network without transcoding and data plane to the PSTN are not shown to avoid obscuring the invention. Referring to FIG. 4, in one embodiment, the system comprises access service network (ASN 410), mobile station 401, connectivity service network (CSN 420), Internet/WiMAX network 431, and PSTN (public switched telephone network) & other voice networks 432. ASN 410 further includes access service network-gateway (ASN-GW 411). CSN 420 further includes authentication, authorization and accounting server (AAA server 421), home agent (HA 422), WiMAX VoIP gateway (WVGW 423), and WiMAX VoIP service server (WVS server 433).

In one embodiment, AAA server 421 communicates with WVS server 433 via V1 471 interface. WVS server 433 communicates with WVGW 423 via V2 472 interface. AAA server 421 communicates with WVGW 423 via V3 473 interface. WVS server 433 communicates with mobile station 401 via R2-V 480 interface.

In one embodiment, WVS server 433 is located in CSN 420 (e.g., with respect to FIG. 4). The difference between FIGS. 4 and 2 is that WVS server 433 is located in CSN 420.

In one embodiment, a network element (e.g., ASN 410, mobile station 401, CSN 420, WVS server 433, ASN-GW 411, AAA server 421, HA 422, and WVGW 423) or an interface (e.g., V1 471, V2 472, V3 473, and R2-V 480), unless otherwise described above, performs functions and roles substantially similar to the corresponding element or the corresponding interface with respect to FIG. 1. For example, ASN-GW 411 performs functionality similar to ASN-GW 111 with respect to FIG. 1; mobile station 401 acts in accordance with mobile station 101 in FIG. 1; etc.

FIG. 5 is block diagram of a wireless communication system where QoS functions are supported by a VoIP gateway in conjunction with a WVS server placed together with the VoIP gateway, in accordance with one embodiment of the invention.

Many related components such as buses and peripherals have not been shown to avoid obscuring the invention. Data plane to IP network without transcoding and data plane to the PSTN are not shown to avoid obscuring the invention. Referring to FIG. 5, in one embodiment, the system comprises access service network (ASN 510), mobile station 501, connectivity service network (CSN 520), Internet/WiMAX network 531, and PSTN (public switched telephone network) & other voice networks 532. ASN 510 further includes access service network-gateway (ASN-GW 511). CSN 520 further includes authentication, authorization and accounting server (AAA server 521), home agent (HA 522), and WiMAX VoIP gateway/WiMAX VoIP service server (WVGW/WVS 523).

In one embodiment, AAA server 521 communicates with WVGW/WVS server 523 via V1 571. WVGW/WVS server 523 communicates with mobile station 501 via R2-V 580. WVGW 523 communicates with ASN-GW 511 via R3-V 581.

In one embodiment, the QoS function is located (performed by) WVGW/WVS server 523. For example, The WVGW and WVS server are collocated or implemented together, such as, for example, on a same physical network server or a network entity. In one embodiment, the combination of WVGW and WVS server is referred to herein as “WVGW/WVS server 523”, “WVGW and WVS server 523”, or WVS server 523.

In one embodiment, V1 571 is an interface between WVGW/WVS server 523 and AAA server 521. V1 571 for WVS subscriber authentication and authorization, and exchanging accounting messages, such as, for example, accounting start, accounting stop, etc.

In one embodiment, R2-V 580 is an interface between mobile station 501 and WVGW/WVS server 523. R2-V 580 is for user registration, deregistration, calling setup and teardown.

In one embodiment, R3-V 581 is an interface between WVGW/WVS server 523 and ASN-GW 511. R3-V 581 for policy distribution and QoS control.

In one embodiment, a network element (e.g., ASN 510, mobile station 501, CSN 520, ASN-GW 511, AAA server 521, HA 522, and WVGW/WVS 523) or an interface (e.g., V1 571, R2-V 580, and R3-V 581), unless otherwise described above, performs functions and roles substantially similar to the corresponding element or the corresponding interface with respect to FIG. 1. For example, ASN-GW 511 performs functionality similar to ASN-GW 111 with respect to FIG. 1; mobile station 501 acts in accordance with mobile station 101 in FIG. 1; etc.

FIG. 6 is block diagram of a wireless communication system where QoS functions are supported by an AAA server in conjunction with a WVS server placed together with the VoIP gateway, in accordance with one embodiment of the invention.

Many related components such as buses and peripherals have not been shown to avoid obscuring the invention. Data plane to IP network without transcoding and data plane to the PSTN are not shown to avoid obscuring the invention. Referring to FIG. 2, in one embodiment, the system comprises access service network (ASN 610), mobile station 601, connectivity service network (CSN 620), Internet/WiMAX network 631, PSTN (public switched telephone network) & other voice networks 632. ASN 610 further includes access service network-gateway (ASN-GW 611). CSN 620 further includes authentication, authorization and accounting server (AAA server 621), home agent (HA 622), and WiMAX VoIP gateway/WiMAX VoIP service server (WVGW/WVS 623).

In one embodiment, AAA server 621 communicates with WVGW/WVS 623 via V1 671. WVGW/WVS 623 communicates with mobile station 601 via R2-V 680.

In one embodiment, the QoS function is located (performed by) AAA server 621. The WVGW and WVS server are collocated or implemented together, such as, for example, on a same physical network server, a network entity. There is no explicit interface between WVGW and WVS Server. In one embodiment, the combination of WVGW and WVS server is referred to herein as “WVGW/WVS server 623”, “WVGW and WVS server 623”, or WVS server 623.

In one embodiment, V1 671 is an interface between WVGW/WVS server 623 and AAA server 621. V1 671 is for WVS subscriber authentication and authorization, policy distribution and QoS control, and exchanging accounting messages, such as, for example, accounting start, accounting stop, etc.

In one embodiment, R2-V 680 is an interface between mobile station 601 and WVGW/WVS server 623. R2-V 680 for user registration, deregistration, calling setup and teardown.

In one embodiment, a network element (e.g., ASN 610, mobile station 601, CSN 620, ASN-GW 611, AAA server 621, HA 622, and WVGW/WVS 623) or an interface (e.g., V1 671, R2-V 680), unless otherwise described above, performs functions and roles substantially similar to the corresponding element or the corresponding interface with respect to FIG. 1. For example, ASN-GW 611 performs functionality similar to ASN-GW 111 with respect to FIG. 1; mobile station 601 acts in accordance with mobile station 101 in FIG. 1; etc.

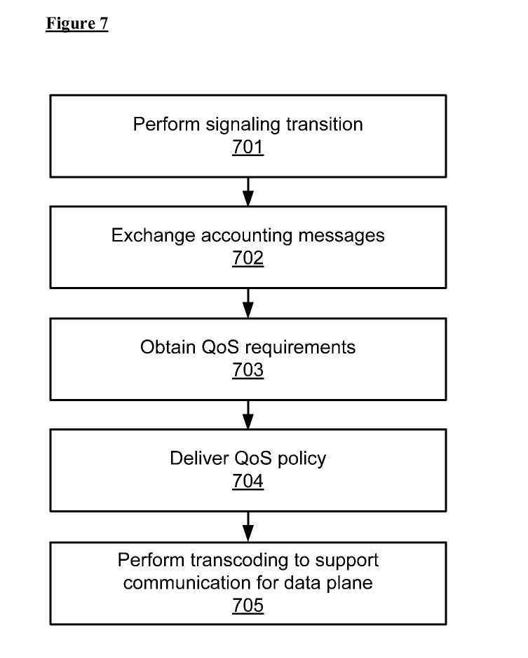

FIG. 7 is a flow diagram of one embodiment of a process to provide VoIP service in conjunction with a WiMAX network. The process is performed by processing logic that may comprise hardware (circuitry, dedicated logic, etc.), software (such as one that is run on a general purpose computer system or a dedicated machine), or a combination of both. In one embodiment, the process is performed in conjunction with a VoIP server (e.g., WVGW 123 and WVS 133 with respect to FIG. 1). FIG. 7 is shown as an example in which process blocks 701-705 may be performed in any sequence, not limited to the order as shown. The process blocks may not have dependency on each others.

Referring to FIG. 7, in one embodiment, processing logic performs signaling transition to support communication for control plane between a WiMAX network and a non-WiMAX network (process block 701). Processing logic performs signal transitioning via an interface between a WVS server and a VoIP gateway to support the signaling transition between the WVS server and other voice systems.

In one embodiment, processing logic performs SIP functions including functionality of a registrar server, a location server, and a redirect server.

In one embodiment, processing logic performs exchanging accounting messages in conjunction with an authentication server (process block 702).

In one embodiment, processing logic performs QoS functions to obtain QoS requirements from a WVS server and to deliver a QoS policy to one or more WiMAX network elements (process blocks 703-704).

In one embodiment, processing logic performs transcoding to support communication for data plane between VoIP clients associated with different codecs (process block 705).

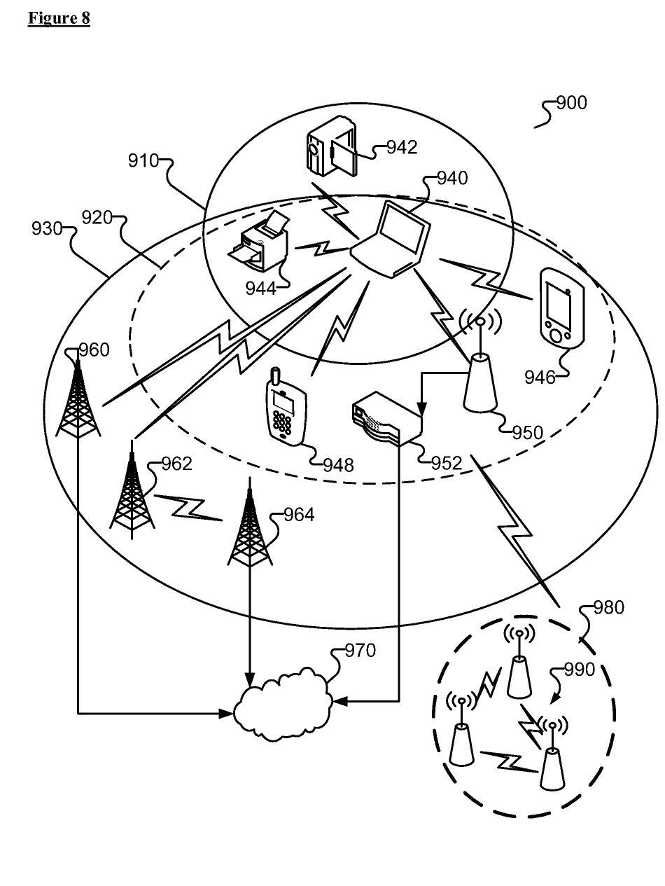

FIG. 8 is a diagram representation of a wireless communication system in accordance with one embodiment of the invention. Referring to FIG. 8, in one embodiment, wireless communication system 900 includes one or more wireless communication networks, generally shown as 910, 920, and 930.

In one embodiment, the wireless communication system 900 includes a wireless personal area network (WPAN) 910, a wireless local area network (WLAN) 920, and a wireless metropolitan area network (WMAN) 930. In other embodiments, wireless communication system 900 includes additional or fewer wireless communication networks. For example, wireless communication network 900 includes additional WPANs, WLANs, and/or WMANs. The methods and apparatus described herein are not limited in this regard.

In one embodiment, wireless communication system 900 includes one or more subscriber stations (e.g., shown as 940, 942, 944, 946, and 948). For example, the subscriber stations 940, 942, 944, 946, and 948 include wireless electronic devices such as, for example, a desktop computer, a laptop computer, a handheld computer, a tablet computer, a cellular telephone, a pager, an audio/video player (e.g., an MP3 player or a DVD player), a gaming device, a video camera, a digital camera, a navigation device (e.g., a GPS device), a wireless peripheral (e.g., a printer, a scanner, a headset, a keyboard, a mouse, etc.), a medical device (e.g., a heart rate monitor, a blood pressure monitor, etc.), and other suitable fixed, portable, or mobile electronic devices. In one embodiment, wireless communication system 900 includes more or fewer subscriber stations.

In one embodiment, subscriber stations 940, 942, 944, 946, and 948 use a variety of modulation techniques such as spread spectrum modulation (e.g., direct sequence code division multiple access (DS-CDMA), frequency hopping code division multiple access (FH-CDMA), or both), time-division multiplexing (TDM) modulation, frequency-division multiplexing (FDM) modulation, orthogonal frequency-division multiplexing (OFDM) modulation, multi-carrier modulation (MCM), other suitable modulation techniques, or combinations thereof to communicate via wireless links.

In one embodiment, laptop computer 940 operates in accordance with suitable wireless communication protocols that require very low power, such as, for example, Bluetooth®, ultra-wide band (UWB), radio frequency identification (RFID), or combinations thereof to implement the WPAN 910. In one embodiment, laptop computer 940 communicates with devices associated with the WPAN 910, such as, for example, video camera 942, printer 944, or both via wireless links.

In one embodiment, laptop computer 940 uses direct sequence spread spectrum (DSSS) modulation, frequency hopping spread spectrum (FHSS) modulation, or both to implement the WLAN 920 (e.g., a basic service set (BSS) network in accordance with the 802.11 family of standards developed by the Institute of Electrical and Electronic Engineers (IEEE) or variations and evolutions of these standards). For example, laptop computer 940 communicates with devices associated with the WLAN 920 such as printer 944, handheld computer 946, smart phone 948, or combinations thereof via wireless links.

In one embodiment, laptop computer 940 also communicates with access point (AP) 950 via a wireless link. AP 950 is operatively coupled to router 952 as described in further detail below. Alternatively, AP 950 and router 952 may be integrated into a single device (e.g., a wireless router).

In one embodiment, laptop computer 940 uses OFDM modulation to transmit large amounts of digital data by splitting a radio frequency signal into multiple small sub-signals, which in turn, are transmitted simultaneously at different frequencies.

In one embodiment, laptop computer 940 uses OFDM modulation to implement WMAN 930. For example, laptop computer 940 operates in accordance with the 802.16 family of standards developed by IEEE to provide for fixed, portable, mobile broadband wireless access (BWA) networks (e.g., the IEEE std. 802.16, published 2004), or combinations thereof to communicate with base stations, shown as 960, 962, and 964, via wireless link(s).

Although some of the above examples are described above with respect to standards developed by IEEE, the methods and apparatus disclosed herein are readily applicable to many specifications, standards developed by other special interest groups, standard development organizations (e.g., Wireless Fidelity (Wi-Fi) Alliance, Worldwide Interoperability for Microwave Access (WiMAX) Forum, Infrared Data Association (IrDA), Third Generation Partnership Project (3GPP), etc.), or combinations thereof. The methods and apparatus described herein are not limited in this regard.

WLAN 920 and WMAN 930 are operatively coupled to network 970 (public or private), such as, for example, the Internet, a telephone network (e.g., public switched telephone network (PSTN)), a local area network (LAN), a cable network, and another wireless network via connection to an Ethernet, a digital subscriber line (DSL), a telephone line, a coaxial cable, any wireless connection, etc., or combinations thereof.

In one embodiment, WLAN 920 is operatively coupled to network 970 via AP 950 and router 952. In another embodiment, WMAN 930 is operatively coupled to network 970 via base station(s) 960, 962, 964, or combinations thereof. Network 970 includes one or more network servers (not shown).

In one embodiment, wireless communication system 900 includes other suitable wireless communication networks, such as, for example, wireless mesh networks, shown as 980. In one embodiment, AP 950, base stations 960, 962, and 964 are associated with one or more wireless mesh networks. In one embodiment, AP 950 communicates with or operates as one of mesh points (MPs) 990 of wireless mesh network 980. In one embodiment, AP 950 receives and transmits data in connection with one or more of MPs 990. In one embodiment, MPs 990 include access points, redistribution points, end points, other suitable connection points, or combinations thereof for traffic flows via mesh paths. MPs 990 use any modulation techniques, wireless communication protocols, wired interfaces, or combinations thereof described above to communicate.

In one embodiment, wireless communication system 900 includes a wireless wide area network (WWAN) such as a cellular radio network (not shown). Laptop computer 940 operates in accordance with other wireless communication protocols to support a WWAN. In one embodiment, these wireless communication protocols are based on analog, digital, or dual-mode communication system technologies, such as, for example, Global System for Mobile Communications (GSM) technology, Wideband Code Division Multiple Access (WCDMA) technology, General Packet Radio Services (GPRS) technology, Enhanced Data GSM Environment (EDGE) technology, Universal Mobile Telecommunications System (UMTS) technology, High-Speed Downlink Packet Access (HSDPA) technology, High-Speed Uplink Packet Access (HSUPA) technology, other suitable generation of wireless access technologies (e.g., 3G, 4G, etc.) standards based on these technologies, variations and evolutions of these standards, and other suitable wireless communication standards. Although FIG. 8 depicts a WPAN, a WLAN, and a WMAN, in one embodiment, wireless communication system 900 includes other combinations of WPANs, WLANs, WMANs, and WWANs. The methods and apparatus described herein are not limited in this regard.

In one embodiment, wireless communication system 900 includes other WPAN, WLAN, WMAN, or WWAN devices (not shown) such as, for example, network interface devices and peripherals (e.g., network interface cards (NICs)), access points (APs), redistribution points, end points, gateways, bridges, hubs, etc. to implement a cellular telephone system, a satellite system, a personal communication system (PCS), a two-way radio system, a one-way pager system, a two-way pager system, a personal computer (PC) system, a personal data assistant (PDA) system, a personal computing accessory (PCA) system, other suitable communication system, or combinations thereof.

In one embodiment, subscriber stations (e.g., 940, 942, 944, 946, and 948) AP 950, or base stations (e.g., 960, 962, and 964) includes a serial interface, a parallel interface, a small computer system interface (SCSI), an Ethernet interface, a universal serial bus (USB) interface, a high performance serial bus interface (e.g., IEEE 1394 interface), any other suitable type of wired interface, or combinations thereof to communicate via wired links. Although certain examples have been described above, the scope of coverage of this disclosure is not limited thereto.

Embodiments of the invention may be implemented in a variety of electronic devices and logic circuits. Furthermore, devices or circuits that include embodiments of the invention may be included within a variety of computer systems. Embodiments of the invention may also be included in other computer system topologies and architectures.

The invention is not limited to the embodiments described, but can be practiced with modification and alteration within the spirit and scope of the appended claims. For example, it should be appreciated that the present invention is applicable for use with all types of semiconductor integrated circuit (“IC”) chips. Examples of these IC chips include but are not limited to processors, controllers, chipset components, programmable logic arrays (PLA), memory chips, network chips, or the like. Moreover, it should be appreciated that exemplary sizes/models/values/ranges may have been given, although embodiments of the present invention are not limited to the same. As manufacturing techniques (e.g., photolithography) mature over time, it is expected that devices of smaller size could be manufactured.

Whereas many alterations and modifications of the embodiment of the present invention will no doubt become apparent to a person of ordinary skill in the art after having read the foregoing description, it is to be understood that any particular embodiment shown and described by way of illustration is in no way intended to be considered limiting. Therefore, references to details of various embodiments are not intended to limit the scope of the claims which in themselves recite only those features regarded as essential to the invention.

What is claimed is:

1. A wireless communication system comprising:
a connectivity service network comprising a voice over internet protocol (VoIP) gateway to enable a VoIP service, wherein the VoIP gateway is operable to perform transcoding function to support VoIP data plane communication.

2. The system of claim 1, wherein the VoIP gateway is a WiMAX (Mobile Worldwide Interoperability for Microwave Access) VoIP gateway, wherein the connectivity service network (CSN) further comprises:
a home agent; and
an authentication, authorization, and accounting server (AAA server) to support quality of service (QoS) control if QoS is not performed by the VoIP gateway.

3. The system of claim 1, further comprising a VoIP service server, wherein the VoIP gateway and the VoIP service server are operable from a same physical server or from two different servers.

4. The system of claim 1, further comprising a VoIP service server which is a WiMAX VoIP service server (WVS) as a part of the connectivity service network.

5. The system of claim 1, wherein the VoIP gateway is operable to perform signaling transition function and quality of service function in conjunction with the VoIP service.

6. The system of claim 1, wherein the connectivity service network further comprises an anchor router if a home agent is not present.

7. The system of claim 1, wherein the VoIP gateway is operable to perform signaling transition to support communication for control plane between a WiMAX network and one or more non-WiMAX networks.

8. The system of claim 1, wherein signaling transition is propagated via the VoIP gateway if the signaling transition is required between a WVS server and a non-WiMAX VoIP system, wherein packets are propagated via the VoIP gateway if the VoIP gateway performs the transcoding function because clients use different codecs.

9. The system of claim 1, wherein the VoIP gateway includes a first interconnection to an AAA Server for exchanging accounting messages, wherein the VoIP gateway includes a second interconnection to access service network-gateway (ASN-GW) for transmitting at least quality of service (QoS) control information.

10. A system comprising a voice over internet protocol (VoIP) service server comprising:
a registrar server;
a location server; and
a redirect server, wherein the VoIP service server is operable to support a VoIP service in conjunction with a WiMAX network.

11. The system of claim 10, wherein the registrar server is a Session Initiation Protocol (SIP) registrar server, wherein the location server is a SIP location server, wherein the redirect server is a SIP redirect server.

12. The system of claim 10, wherein the VoIP service server is a WiMAX VoIP service server (WVS) which includes a first interface with an AAS server to perform subscriber authentication, and exchanging accounting messages,

13. The system of claim 12, wherein the WVS further includes QoS functions if there is no VoIP gateway.

14. The system of claim 10, wherein the VoIP service server includes an interconnection to a VoIP gateway to communicate QoS control and to perform signaling transition between the VoIP service server and other voice systems.

15. The system of claim 10, wherein the VoIP service server communicates with a mobile station to perform user registration, deregistration, calling setup, and calling teardown.

16. A method for a wireless communication network comprising:
performing signaling transition to support communication for control plane between a WiMAX network and a non-WiMAX network; and
performing transcoding to support communication for data plane between VoIP clients associated with different codecs.

17. The method of claim 16, further comprising performing, by a VoIP gateway or an AAS server, QoS functions to obtain QoS requirements from a WVS server and to deliver QoS policy to one or more WiMAX network elements.

18. The method of claim 16, further comprising performing, by a VoIP gateway, signal transitioning via an interface between a WVS server and the VoIP gateway to support the signaling transition between WVS and other voice systems.

19. The method of claim 16, further comprising performing, by a WVS server, SIP functions including functionality of a registrar server, a location server, and a redirect server.

20. The method of claim 16, further comprising performing, by a WVS server, exchanging accounting messages in conjunction with an authentication server.
